(19) United States
(12) Patent Application Publication
(10) Pub. No.: US 2023/0351417 A1
(43) Pub. Date: Nov. 2, 2023

(54) SYSTEM AND METHOD FOR AUTOMATIC OPTIMIZATION OF USER ENGAGEMENT ON A DIGITAL PLATFORM

(71) Applicant: FLIPKART INTERNET PRIVATE LIMITED, Bengaluru (IN)

(72) Inventors: Puneet Kumar GUPTA, Bhopal (IN); Ashish GUPTA, Secunderabad (IN); Rishabh SRIVASTAVA, Jaipur (IN)

(73) Assignee: FLIPKART INTERNET PRIVATE LIMITED, Bengaluru (IN)

(21) Appl. No.: 17/847,889

(22) Filed: Jun. 23, 2022

(30) Foreign Application Priority Data
Apr. 28, 2022 (IN) 202241025062

(51) Int. Cl. G06Q 30/02

(52) U.S. Cl. CPC G06Q 30/0201; G06Q 30/0209

(57) ABSTRACT

A system and method for automatic optimization of user engagement on a digital platform is provided. The method comprises generating, a set of tokens for a gamified challenge on the digital platform. The method thereafter leads to associating token(s) from the set of tokens with a set of levels of the gamified challenge. Further the method encompasses providing to user(s) via the digital platform, action item(s) at least to enable the user(s) to retrieve token(s) from the set of tokens and to permit the user(s) to transition to a next level from a current level. Further the method comprises determining for each level, a probability of retrieving the token(s) by the user(s). The method thereafter encompasses automatically controlling, a number of users permitted to transition to the next level from the current level based on the determined probability, to automatically optimize the user engagement on the digital platform.

### TECHNICAL FIELD

The present invention generally relates to automatic optimization solutions for digital platforms and more particularly to systems and methods for automatic optimization of user engagement on a digital platform.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Over the past few years the digital technologies have been enhanced to a great extent. With the advancement in digital technologies, it is now possible for the user of electronic devices such as smartphones, laptops etc. to access various facilities digitally. For instance, the users of the electronic devices can easily access the digital platforms such as an e-commerce platform to avail facilities to buy/sell products digitally. Further, for a digital platform to efficiently provide various facilities to its users, it is important to manage and optimize the user engagement on such digital platform. For any digital platform, getting more users is the toughest problem to solve. Usually digital platforms try out different ways to lure users on-board. Mostly, all the ideas become a balancing act between incremental users brought on the digital platform with additional cash or reward burn. Few examples are, paid installs, digital marketing, social media Ads, etc. These are nothing but optimization problems where cash or reward burn is one of the biggest constraints in addition to other limitations.

A gamified challenge on a digital platform is a construct that is aimed at driving user engagement on the digital platform during an intrigue period, and achieving conversion goodness during at least some sales events on the digital platform. More specifically, gamification is a strategic attempt to enhance services and/or activities etc. associated with digital platforms, under which experiences similar to those experienced when playing games are created in order to motivate and engage users on the digital platforms. This is generally accomplished through the application of game-design elements and game principles (dynamics and mechanics) in non-game contexts. Generally, a gamified challenge provided on a digital platform includes a game that is designed to: make users of such digital platform aware about events and deals etc. on the digital platform and educate the users on various action items on the digital platform. The action items are necessary user actions that allow the users to become accustomed to the digital platform as well as convert better in the long term. Also, the action items may be associated with some kind of rewards to increase user engagement on the digital platform. For instance, if a user performs an action say adding a product to a virtual cart on an e-commerce platform, the user may get an immediate monetary reward. Further action item-based challenges in a game provided on a digital platform are targeted actions completion of which leads to long term goodness. For instance, rewards such as monetary rewards etc. provided to users can be utilized to avail facilities provided by the digital platform.

Therefore, gamification on the digital platforms is part of persuasive system design that commonly employs game design elements to improve user engagement, organizational productivity, learning, knowledge retention, ease of use, usefulness of various elements of digital platforms and more. However, there are a number of limitations of the gamified challenges/gamification provided on the digital platforms. For instance, the gamified challenges that are currently known in the art are generally guesstimated guidelines based on a business judgment. Also, these gamified challenges are associated with a high cash and/or reward burn, and in these gamified challenges a user who completes tasks or challenges leading to a reward/monetary-reward needs to be constantly monitored. Further, in such currently known gamification-based solutions of user engagement, a manual intervention based on business knowledge is required. In addition, a real time manual evaluation at each level and manual control of flow of users from one level to another is also required which is not feasible at least because of the amount of data that is required to be monitored, unpredictability in user engagement prediction, and high chances of human errors etc. For instance, currently depending on the flow of users moving from one level to another in a gamified challenge, multiple attributes need to be manually increased/decreased while keeping reward burn in check, therefore constant manual monitoring is required. Also, in the known solutions constant manual monitoring is required as the user flow control is not gradual on the digital platforms and users may be required to be cut off at levels from moving forward once the threshold for reward burn at each level is reached. Furthermore, one additional limitation of the constant manual monitoring of a large data is a constant requirement of a large number of technical and human resources, that leads not only to technical losses but also to economic losses.

Therefore, there are a number of limitations of the current solutions and there is a requirement of a technical solution that may automatically control a successful flow of users transitioning from one level to the next in a gamified challenge provided on digital platforms for optimization of user engagement. Also, there is a requirement of a technical solution that is capable of optimally controlling a funnel approved for optimization of user engagement based on a pre-defined constraint such as a reward burn, etc. The present disclosure therefore overcomes such limitations by providing a method and system for automatic optimization of user engagement on a digital platform.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for automatic optimization of user engagement on a digital platform. Also, an object of the present invention is to provide automatic optimization of user engagement on a digital platform by providing one or more gamified challenges on the digital platform. Another object of the present invention is to provide a solution that can minimize the complexity of the existing solutions of optimization of user engagement where cash/reward burn is one of the major constraints. Also, an object of the present invention is to make users familiar with the digital platform(s) using the gamified challenge(s) provided on a digital platform. Another object of the present invention is to provide a solution that follows one or more pre-defined constraints while automatically optimizing user engagement on a digital platform based on gamified challenge(s). Yet another object of the present invention is to provide to users of digital platforms via a gamified challenge, one or more action items which have been identified as pivotal before placing an order on the digital platform, therefore once the users are comfortable in executing these action items on the digital platforms they become more comfortable with the digital platforms that in turn allows the users to place an order with ease.

Furthermore, in order to achieve the aforementioned objectives, the present invention provides a method and system for automatic optimization of user engagement on a digital platform.

A first aspect of the present invention relates to the method for automatic optimization of user engagement on a digital platform. The method comprises generating, by a processing unit, a set of tokens for a gamified challenge on the digital platform. The method thereafter leads to associating, by the processing unit, one or more tokens from the set of tokens with a set of levels associated with the gamified challenge. Further the method encompasses providing, by the processing unit to one or more users via the digital platform accessed on one or more user device, one or more action items. The one or more action items are provided to enable the one or more users to retrieve one or more tokens from the set of tokens. Also, the one or more action items are associated with one or more rewards, and the one or more action items are provided to permit the one or more users to transition to a next level from a current level. Further the method comprises determining for each level from the set of levels, by the processing unit, a probability of retrieving the one or more tokens from the set of tokens by the one or more users. The probability for each level is determined based on at least one of a pre-defined constraint and a probability determined for one or more previous levels of said each level. The method thereafter encompasses automatically controlling, by a control unit, a number of users permitted to transition to the next level from the current level based on the probability determined for each level from the set of levels. Also, the method then leads to automatically optimizing, by an optimization unit, the user engagement on the digital platform based on the automatic controlling of the number of users permitted to transition to the next level from the current level.

Another aspect of the present invention relates to a system for automatic optimization of user engagement on a digital platform. The system comprises at least a processing unit, a control unit and an optimization unit. The processing unit is configured to: generate, a set of tokens for a gamified challenge on the digital platform, associate, one or more tokens from the set of tokens with a set of levels associated with the gamified challenge, and provide to one or more users via the digital platform accessed on one or more user device, one or more action items. The one or more action items are provided to enable the one or more users to retrieve one or more tokens from the set of tokens. Also, the one or more action items are associated with one or more rewards, and the one or more action items are provided to permit the one or more users to transition to a next level from a current level. Further the processing unit is also configured to determine for each level from the set of levels, a probability of retrieving the one or more tokens from the set of tokens by the one or more users. The probability for each level is determined based on at least one of a pre-defined constraint and a probability determined for one or more previous levels of said each level. Also, the control unit is configured to automatically control, a number of users permitted to transition to the next level from the current level based on the probability determined for each level from the set of levels. Further, the optimization unit is configured to automatically optimize the user engagement on the digital platform based on the automatic controlling of the number of users permitted to transition to the next level from the current level.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for automatic optimization of user engagement on a digital platform, in accordance with exemplary embodiments of the present invention.

FIG. 2 illustrates an exemplary method flow diagram [200], for automatic optimization of user engagement on a digital platform, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from an optimization unit, a control unit, a processing unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section, existing technologies have many limitations and in order to overcome at least some of the limitations of the prior known solutions, the present disclosure provides a solution of automatic optimization of user engagement on a digital platform based on a gamified challenge provided on the digital platform. In a preferred implementation the digital platform is an e-commerce platform but the present disclosure is not limited thereto and in other implementations the digital platform may be any other digital platform that is obvious to a person skilled in the art. More specifically the present disclosure provides a most feasible solution for a user engagement optimization problem under pre-defined constraints such as including but not limiting to a cost or a reward related constraint defined for a gamified challenge provided on a digital platform. The solution as disclosed in the present disclosure automatically optimizes the user engagement on a digital platform by letting the users of the digital platform to transition optimally from one level to another in a gamified challenge provided on the digital platform by controlling the amount of users who transition to a next level based on one or more pre-defined constraints. In a preferred implementation, the solution as disclosed in the present disclosure automatically overcomes the technical problems related to optimization of user engagement on a digital platform that arises when the users in a gamified challenge provided on the digital platform start to flow to the last level too quickly depicting Cash/Reward Burn, and/or when the users start to flow too slow to the last level depicting suboptimal use of the space/feature/construct provided for optimization of user engagement. Also, the solution as disclosed in the present disclosure considers the distribution of possible combinations of one or more tokens generated for a gamified challenge (i.e., for instance a token may be referred as an “in game currency” generated for a gamified challenge) and has applications of the concept of expected value under probability to create a framework controlling the flow of the users reaching a next level in the gamified challenge as opposed to manual intervention.

Therefore, the present invention provides a novel solution of automatic optimization of user engagement on a digital platform based on a gamified challenge. The present invention also provides a technical advancement over the currently known solutions by providing an automated control over the user movement across various levels of a gamified challenge on a digital platform without any manual monitoring. Also, the present invention is technically advanced over the currently known solutions as the increased control of user flow provided via the present solution converts to better rewards for the end-users given that the chances of exceeding the budget (i.e., the available rewards to be distributed) are practically nil. The present invention is also technically advanced over the currently known solutions as it provides a solution to adjust a probability of retrieving tokens at a given level based on a current number of users transitioning to a next level from a current level and/or a drop of rate of users, wherein changing a probability at a given level, gives an automated output in terms of the user movement across multiple levels. Furthermore, the present invention is also technically advanced over the currently known solutions as using the present solution multiple simulations can be created by changing different probabilities and output against each simulation can be observed which leads to strong data based output.

Hereinafter, exemplary embodiments of the present disclosure will be described in detail with reference to the accompanying drawings so that those skilled in the art can easily carry out the present disclosure.

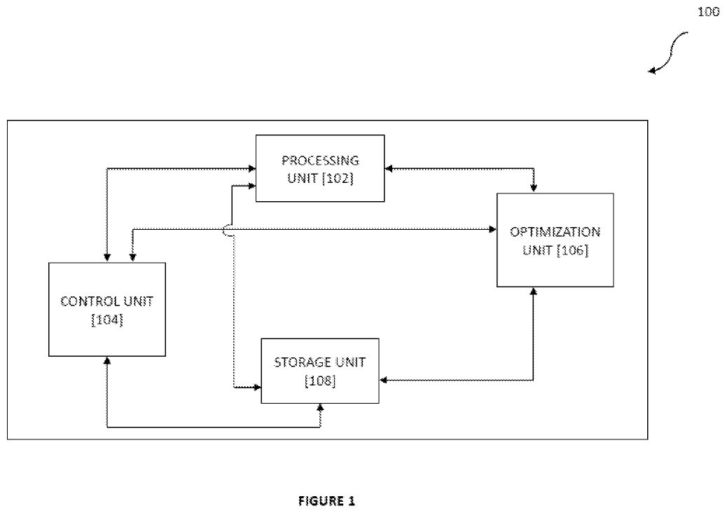

Referring to FIG. 1, an exemplary block diagram of a system [100] for automatic optimization of user engagement on a digital platform is shown. The system [100] provides one or more hardware units for implementing a method of automatic optimization of user engagement on the digital platform. As shown in FIG. 1, the system [100] comprises at least one processing unit [102], at least one control unit [104], at least one optimization unit [106] and at least one storage unit [108]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] may be present in a server device to implement the features of the present invention.

The system [100] is configured to automatically optimize user engagement on a digital platform, with the help of the interconnection between the components/units of the system [100]. In a preferred implementation the digital platform is an e-commerce platform but the present disclosure is not limited thereto and in other implementations the digital platform may be any other digital platform that is obvious to a person skilled in the art.

The processing unit [102] of the system [100] is connected to, the at least one control unit [104], the at least one optimization unit [106] and the at least one storage unit [108]. In an implementation the control unit [104] and the optimization unit [106] may be hardware units that are same or similar to as that of the processing unit [102] and are configured to perform their respective functions as required to implement the features of the present disclosure. Also, in order to implement the features of the present disclosure the processing unit [102] is configured to generate, a set of tokens for a gamified challenge on the digital platform. In an implementation the set of tokens are generated by the processing unit [102] prior to launching the gamified challenge on the digital platform. The gamified challenge is a digital game based challenge is launched on the digital platform for automatic optimization of user engagement on the digital platform at least by making users who are opting the gamified challenge familiar with the digital platform in most optimal manner using the gamified challenge. In order to provide automatic optimization of the user engagement on the digital platform in an efficient manner, the gamified challenge i.e., the digital game is built such that a storyline and a number/set of levels are associated with the gamified challenge, and the gamified challenge is implemented on the digital platform for a pre-defined number of days. For example, for an e-commerce platform a gamified challenge may be a game based challenge that is implemented/launched on the e-commerce platform for 20 days during a sales event for automatic optimization of user engagement on the e-commerce platform, wherein such game based challenge may have n number of levels, where in such example n may be 6 or any other number. Further in an implementation the set of tokens are generated for the gamified challenge prior to launching the gamified challenge on the digital platform, to avoid a change in the number of tokens once the gamified challenge is launched, which further helps in optimization of user engagement in more efficient manner. For example, if on a digital platform a gamified challenge ‘A’ is to be launched for optimization of user engagement during a 3 days sales event. Then a number of tokens that can be distributed among the users once the gamified challenge ‘A’ is live on the digital platform are first determined such that no further change in the number of tokens is possible once the gamified challenge ‘A’ is live. Also, as the number of tokens are fixed, a variance in at least a user flow due to a changing number of token is not present, and hence user engagement optimization is more efficient. Also, the set of tokens may comprise one or more tokens and in an implementation as used herein a “token” may be referred as an “in game currency” generated for the gamified challenge. In an example, a game currency/a token may be in a form of a digital coin, a digital card or any such digital representation that is obvious to a person skilled in the art and that can be used by users to purchase items, etc. on the digital platform. Further in the implementation where the set of tokens comprises a plurality of tokens, one or more tokens from such plurality of tokens may be of a same kind or a different kind, for example a set of tokens may comprise one token ‘A’, one token ‘B’, five token ‘C’ etc.

Once the set of tokens is generated, the processing unit [102] is then configured to associate, one or more tokens from the set of tokens with the set of levels associated with the gamified challenge. The set of levels may comprise ‘n’ number of levels or digital milestones, where n may be any number from 1, 2, . . . , N or ‘n’∈{1, 2, . . . , N}, such that when n=1 the level is a beginner level or beginner digital milestone i.e., level 1, and n=2 (i.e., level 2) can be reached once the level 1 is clear and so on. In an implementation with the 1^{st} level from the set of levels, 1^{st} token(s) from the set of tokens may be associated; with the 2^{nd} level from the set of levels, 2^{nd} token(s) from the set of tokens or a combination of 1^{st} and 2^{nd} token(s) from the set of tokens may be associated; with the 3^{rd} level from the set of levels, 3^{rd} token(s) or a combination of 1^{st}, 2^{nd} and/or 3^{rd} token(s) from the set of tokens may be associated and so on, but the disclosure is not limited thereto.

The association of the one or more tokens from the set of tokens with the one or more levels from set of levels indicates a requirement of token(s) at the one or more levels to transition from the one or more levels to a next level. Furthermore, each level from the set of levels are further associated with one or more action items and/or one or more rewards. As used herein an action item associated with each level may be any action that can make users of the digital platform more familiar with the digital platform but the disclosure is not limited thereto. In an example an action item may include but not limited to completing a task/action on the digital platform, performing daily check-ins/streaks on the digital platform, exchanging one or more tokens within users of the digital platform, and an invite and earn action on the digital platform etc. Also, as used herein a reward may be a monetary reward but the disclosure is not limited thereto and there may be other reward(s) such as a coupon, an access to a digital service and/or the like digital reward(s). In an example, a reward associated with a level of a gamified challenge may be given to a user upon completion of such level by the user, wherein such completion of the level is based on the performing the one or more action by the user to get the token(s) required to complete the level. Therefore, in an implementation a user needs to collect particular token(s) or combination of tokens to complete each level of a gamified challenge. Further in such implementation upon reaching the required token(s) or the token combination for an active level, the user may be awarded with a targeted reward such as for example a targeted monetary a reward available for that active level. For such implementation the required number of tokens may be denoted as ‘rₙ’ where 1<rₙ≤kₙ.

Further, once the one or more tokens from the set of tokens are associated with the set of levels associated with the gamified challenge, the processing unit [102] is configured to provide to one or more users via the digital platform accessed on one or more user device, the one or more action items. The one or more action items are provided to enable the one or more users to retrieve one or more tokens from the set of tokens. Also, the one or more action items are provided to permit the one or more users to transition to a next level from a current level based on the retrieval of the one or more tokens from the set of tokens required to transition to the next level. For example a user may execute a provided action item such as the user may complete a selection of 10 products on an e-commerce platform to get say 5 tokens ‘A’ that are required to complete a 1^{st} level of a gamified challenge launched on the e-commerce platform, wherein selection of products further makes the user more familiar with the e-commerce platform in at least the terms of product selection. Further, the one or more action items are also associated with the one or more rewards. More specifically as the one or more action items enable the one or more users to retrieve the one or more tokens required for completion of the one or more levels, therefore awarding the one or more rewards to the one or more users upon the completion of the one or more levels is based on the one or more action items.

Also, in an implementation each action item from the one or more action items may be further associated with the storyline associated with the gamified challenge. In an implementation, the storyline includes but is not limited to a number of actions required to be performed in sequential and/or non-sequential manner at each level of the gamified challenge to complete such level. For example, if a gamified challenge is implemented on an e-commerce platform for 3 days then for day 1 the storyline may include but not limited to selecting a product, adding a product to a virtual cart, and performing a product filtering action etc. actions that are required to be performed in sequential and/or non-sequential manner at a 2^{nd} level of the gamified challenge. Also, in an implementation, completion of the one or more action items in the sequential and/or non-sequential manner may be considered as one or more trials to win and a trial to win may be denoted by ‘t’, where ‘t’ ∈{1, 2, . . . , T}∥T is the maximum trials a user can take during the time period when the gamified challenge is launched/active. Furthermore, in one other implementation the one or more action items may be provided based on a pre-defined time limit. For example, if a gamified challenge is implemented on an e-commerce platform for 3 days then for day 1, 4 action items for a level say for level 1 of the gamified challenge may be provided for 2 times. Also, an exemplary table i.e., table 1 indicating action items/trails provided for a gamified challenge say ‘A’ on a daily basis is provided as below:

TABLE 1

| Levels | Total action items/trails | Refresh rate per day |
|---|---|---|
| L1 | 1 | 0 |
| L2 | 4 | 2 |
| L3 | 6 | 4 |
| L4 | 6 | 4 |
| L5 | 6 | 4 |
| L6 | 6 | 4 |

In an example if the above gamified challenge ‘A’ launched for ˜20 days i.e., maximum trials for a user playing for all 20 days is ˜301 trials i.e. {t∈R: 1≤t 301}.

The processing unit [102] is then configured to determine for each level from the set of levels, a probability of retrieving the one or more tokens from the set of tokens by the one or more users. For instance, for the one or more levels from the set of levels the processing unit [102] determines an associated cumulative probability of completion of said one or more levels by one or more users. In an implementation the cumulative probability of completion of any level n is ‘P(n)’, where P(n)∈[0,1]. Further, the probability for each level is determined based on at least one of a pre-defined constraint and a probability determined for one or more previous levels of said each level. Also, in an implementation the pre-defined constraint is defined based at least on an expected number of users transitioning to the next level from the current level. Also, the expected number of users is determined based at least on a number of rewards to be distributed at each level from the set of levels. In an implementation the expected number of users for a current level may also be determined based on the expected number of users for one or more previous levels. Further an exemplary table i.e., table 2 is provided below that is depicting an expected % users that can be allowed to reach the next level from 6 different levels, where for a level the depicted % is such that a reward burn is balanced with the maximum users that can be allowed to reach a next level.

TABLE 2

| Levels | UV funnel approved | Cumulative funnel |
|---|---|---|
| Level 1 | 100.00% | 100.00% |
| Level 2 | 90.00% | 90% |
| Level 3 | 75.00% | 68% |
| Level 4 | 50.00% | 34% |
| Level 5 | 40.00% | 14% |
| Level 6 | 10.00% | 1% |

Also, an exemplary table i.e., table 3 is provided below that is depicting exemplary probabilities at a ‘token X level’ stage, where n-no. of level, k-token:

TABLE 3
Working probabilities (Pₙₖ)

| | | Token Nature | L1 | L2 | L3 | L4 | L5 | L6 |
|---|---|---|---|---|---|---|---|---|
| Tokens | Token 1 | Abundant | P(Xₙ₁) | P(Xₙ₁) | P(Xₙ₁) | P(Xₙ₁) | P(Xₙ₁) | P(Xₙ₁) |
| | Token 2 | Common | P(Xₙ₂) | P(Xₙ₂) | P(Xₙ₂) | P(Xₙ₂) | P(Xₙ₂) | P(Xₙ₂) |
| | Token 3 | Infrequent | P(Xₙ₃) | P(Xₙ₃) | P(Xₙ₃) | P(Xₙ₃) | P(Xₙ₃) | P(Xₙ₃) |
| | Token 4 | Rare | P(Xₙ₄) | P(Xₙ₄) | P(Xₙ₄) | P(Xₙ₄) | P(Xₙ₄) | P(Xₙ₄) |

Thus, in an implementation retrieval of a token upon completion of the one or more action items depends on a probability function which takes a level as an input. Also, in such implementation in-game tokens may be denoted by ‘Xₖ’∥k∈ {1, 2, . . . , K} and a number of tokens the one or more users may collect in the gamified challenge over levels may be denoted by ‘xₖ’∥k∈{1, 2, . . . , K}, where sum of all ‘xₖₙ’ for a level ‘n’ is equal to ‘tₙ’. Further, in an implementation the one or more tokens retrieved by the one or more users may be carry forwarded to the next level after deduction of the required tokens for a current level.

Further, after determining the probability of retrieving the one or more tokens from the set of tokens by the one or more users, an indication of the same is provided to the control unit [104] of the system [100] by the processing unit [102], where the control unit [104] is connected to the processing unit [102], the optimization unit [106] and the storage unit [108]. Also, the control unit [104] is then configured to automatically control, a number of users permitted to transition to the next level from the current level based on the probability determined for each level from the set of levels. More specifically, for automatically controlling the number of users permitted to transition to the next level from the current level, the control unit [104] is further configured to adjust the probability determined for each level from the set of levels based on at least of a current number of users transitioning to the next level from the current level and a drop off rate. The drop off rate is a rate at which users opts out of the gamified challenge within a given time period. Also, in an implementation the number of users who may complete any level n is denoted by a function EV(n), such that:

EV(n)=∥(P(n),P(n−1))
Where,
n is the level number,
EV(n) is the expected value of the probability of the users that cross a level n,
P(n) is the probability of a user crossing a current level, and
P(n−1) is the probability of a user crossing a previous level.

Once the number of users permitted to transition to the next level from the current level is automatically controlled, the optimization unit [106] of the system [100] that is connected to the processing unit [102], the control unit [104] and the storage unit [108] is configured to automatically optimize the user engagement on the digital platform based on the automatic controlling of the number of users permitted to transition to the next level from the current level.

Therefore, the system [100] uses the conditional probabilities and expected value to identify how the users are going to traverse through the levels of a gamified challenge, where the probabilities of each in-game currency is programmable and can be tweaked at any point in time. Also, the system [100] calculates the optimal probability on at least the basis of multinomial distribution of the in-game currency which in turn are based on pre-defined constraints.

Furthermore, an exemplary implementation where the optimization problem is solved based on the implementation of the features of the present invention is provided as below:
1. Conversion into a Binary distribution from a multinomial distribution: In order to simplify the problem, each level of a gamified challenge/game may only be dependent on 1 token, if the requirement for that token is fulfilled user will complete the level automatically.
2. Assuming a fixed value of ‘t’ to limit the number of trials to limit the number of cases that may need to be considered: Based on pre-defined constraints, y number of days say for example 3 days may be considered to be the maximum number of days users will try the game without completing a level, post which they may drop off and never come back to the game. I.e. {t∈R: 1<t≤63}

Solving a Binomial Distribution of Levels

Simplifying ‘rₙ’ for majority of the levels:

To identify what is the optimal number of token required, scenarios are considered to come up with an optimal number that balances the complete game funnel close to the funnel defined for a number of users that can be allowed to reach a next level, where the constraints are also considered:

1≤rₙₖ≤xₖ≤tₙ
n-level, k-token number, xₖ-collected tokens

At any given level, there may only be 2 active tokens, and the completion of the level is dependent on the one of the tokens being received after completion of the tasks per action item. Probability of a receiving of at least 1 token may be given by:

P(n)_{binomial}=1−(p(Xₙₖ)^{t}^{ₙ})

Where, p(Xₙₖ)—probability of getting a token in level n

Example,

For Level 2: ‘Token 2’ may be kept as the bottleneck with lower probability of being received, i.e., completion of level 2 is hence given as probability of receiving at least 1 Token 2 over the no. of trials that the user takes.

Solving a Multinomial Distributions for the Levels

To calculate the probability of a given level, for a particular combination of in-game currencies the multinomial distribution may be used to calculate the probability of each scenario.

$$P ( {X}_{1} = {x}_{1} , {X}_{2} = {x}_{2} , … , {X}_{k} = {x}_{k} ) = ( \frac{n !}{{x}_{1} ! {x}_{2} ! … {x}_{k} !} ) {p}_{1}^{{x}_{1}} {p}_{2}^{{x}_{2}} … {p}_{k}^{{x}_{k}}$$

Where,
X₁, X₂, . . . , Xₖ are the in-game currencies
x₁, x₂, . . . , xₖ are the number of in-game currencies collected by the user in a given level

i.e. Σ(x₁, x₂, . . . , xₖ)=tₙ

Then the total users who have collected more or equal amounts of in-game currencies in a given level are calculated.

$${P ( n )}_{multinomial} = {\sum }_{1}^{{r}_{nk}} \frac{t !}{{x}_{n 1} ! {x}_{n 2} ! … {x}_{n k} !} {p}_{n 1}^{{x}_{n 1}} {p}_{n 2}^{{x}_{n 2}} … {p}_{nk}^{{x}_{nk}} ‖ ∀ {x}_{k} ∈ {x}_{nk} \geq r$$

Where, r-required number of tokens in the level

Example, in level 4, the user may require 2 Token 2, and 2 Token 3 to complete the game.

$$P ( n ) = {\sum }_{0}^{2} \frac{t !}{{x}_{n 2} ! {x}_{n 3} !} p ( {X}_{n 2} ) \qquad {x}_{n 2} \qquad p ( {X}_{n 3} ) \qquad {x}_{n 3}$$

Final Solution:

A system of equations created and applied in the simplest format to arrive at the final Expected value of users at each milestone (completion of the level).

The users who may complete any level n is denoted by a function EV(n), such that:

EV(n)=ΠP(n),P(n−1))
Where,
n is the level number,
EV(n) is the expected value of the probability of the users that cross a level n,
P(n) is the probability of a user crossing the current level, and
P(n−1) is the probability of the user crossing the previous level.

By using this flow, the probabilities at each level of the available tokens can be tweaked, for instance if a lot of users try to game the system by performing a particular action item say by referring users onto the game, the probability of tokens required can be further throttled down to achieve an expected level of users crossing a threshold.

Furthermore, an experimental result after completion of a game/gamified challenge based on the implementation of the features of the present disclosure is provided as below:

In the experiment the final values of (‘rₙₖ’) tokens decided as:

| Levels | Tokens required |
|---|---|
| L1 | 1 Token A |
| L2 | 1 Token A + 2 Token B |
| L3 | 1 Token C + 2 Token B |
| L4 | 2 Token C + 2 Token B + 5 Token A |
| L5 | 1 Token D + 8 Token A + 1 Token C |
| L6 | 2 Token D + 9 Token A + 2 Token B |

The final probabilities ‘p(Xₙₖ)’ configured:

Final probabilities

| | | | L1 | L2 | L3 | L4 | L5 | L6 |
|---|---|---|---|---|---|---|---|---|
| Tokens | Token A | Abundant | 1 | 0.7 | 0.87 | 0.82 | 0.565 | 0.58 |
| | Token B | Common | 0 | 0.3 | 0 | 0.09 | 0.2 | 0.2 |
| | Token C | Infrequent | 0 | 0 | 0.13 | 0.09 | 0.2 | 0.2 |
| | Token D | Rare | 0 | 0 | 0 | 0 | 0.035 | 0.02 |

Funnel View

After the completion of the game an expected funnel depicting an expected completion rate at a starting of the gaming event and a final funnel depicting an observed completion rate at an ending of the gaming event seen as below, where completion rate indicates a rate of completion of a level by the users:

| | Cumulative expected funnel at | Cumulative Completion rate |
|---|---|---|
| Levels | the start of the event | at end of the event |
| Level 1 | 70.00% | 48.06% |
| Level 2 | 56.00% | 18.17% |
| Level 3 | 19.60% | 10.97% |
| Level 4 | 5.88% | 4.78% |
| Level 5 | 2.06% | 1.17% |
| Level 6 | 0.19% | 0.19% |

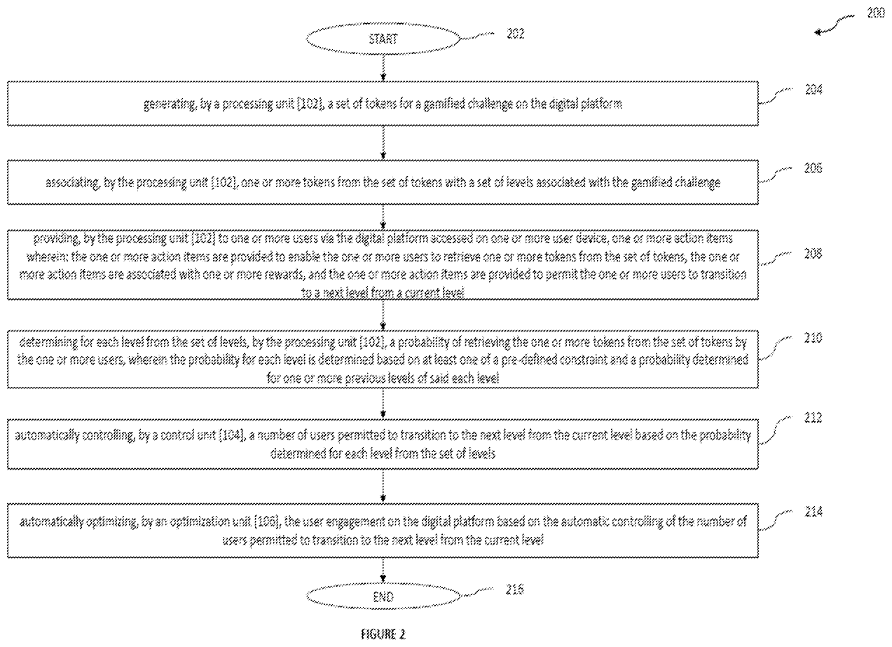

Referring to FIG. 2 an exemplary method flow diagram [200], for automatic optimization of user engagement on a digital platform, in accordance with exemplary embodiments of the present invention is shown. In an implementation the method is performed by the system [100]. Further, in an implementation, the system [100] may be present in the server device to implement the features of the present invention. Also, as shown in FIG. 2, the method starts at step [202] for automatic optimization of user engagement on the digital platform. In a preferred implementation the digital platform is an e-commerce platform but the present disclosure is not limited thereto and in other implementations the digital platform may be any other digital platform that is obvious to a person skilled in the art.

Further, at step [204] the method comprises generating, by the processing unit [102], a set of tokens for a gamified challenge on the digital platform. The gamified challenge is launched on the digital platform for automatic optimization of user engagement on the digital platform at least by making users who are opting the gamified challenge familiar with the digital platform in most optimal manner using the gamified challenge. In order to provide automatic optimization of the user engagement on the digital platform in an efficient manner, the gamified challenge is built such that a storyline and a number/set of levels are associated with the gamified challenge, and the gamified challenge is implemented on the digital platform for a pre-defined number of days. For example, for an e-commerce platform a gamified challenge may be a game based challenge or a game that is implemented/launched on the e-commerce platform for 5 days during a sales event for automatic optimization of user engagement on the e-commerce platform, wherein such game based challenge may have n number of levels, where in such example n may be 4 or any other number. Further in an implementation the set of tokens are generated for the gamified challenge prior to launching the gamified challenge on the digital platform, to avoid a change in the number of tokens once the gamified challenge is launched, which further helps in optimization of user engagement in more efficient manner. Also, the set of tokens may comprise one or more tokens and in an implementation as used herein a “token” may be referred as an “in game currency” generated for the gamified challenge. In an example an in game currency/a token may be in a form of a digital coin, a digital card or any such digital representation that is obvious to a person skilled in the art. Further in the implementation where the set of tokens comprises a plurality of tokens, one or more tokens from such plurality of tokens may be of a same kind or a different kind, for example a set of tokens may comprise two token ‘A’, six token ‘B’, four token ‘C’, 9 token ‘D’ etc.

Once the set of tokens is generated, next at step [206] the method comprises associating, by the processing unit [102], one or more tokens from the set of tokens with a set of levels associated with the gamified challenge. The set of levels may comprise ‘n’ number of levels where n may be any number from 1, 2, . . . , N or ‘n’ ∈{1, 2, . . . , N}. In an implementation with the 1^{st} level form the set of levels 1^{st} token(s) from the set of tokens may be associated, with the 2^{nd} level form the set of levels 2nd token(s) from the set of tokens or a combination of 1^{st} and 2^{nd} token(s) from the set of tokens may be associated, with the 3rd level form the set of levels 3^{rd} token(s) or a combination of 1^{st} a, 2^{nd} and/or 3rd token(s) from the set of tokens may be associated and so on, but the disclosure is not limited thereto. The association of the one or more tokens from the set of tokens with the one or more levels from set of levels indicates a requirement of token(s) at the one or more levels to transition from the one or more levels to a next level. Furthermore, each level from the set of levels are further associated with one or more action items and/or one or more rewards. As used herein an action item associated with each level may be any action that can make users of the digital platform more familiar with the digital platform but the disclosure is not limited thereto. In an example an action item may include but not limited to completing a task/action on the digital platform, performing daily check-ins/streaks on the digital platform, exchanging one or more tokens within users of the digital platform, and an invite and earn action on the digital platform etc. Also, as used herein a reward may be a monetary reward but the disclosure is not limited thereto and there may be other reward(s) such as a coupon, an access to a digital service and/or the like digital reward(s). In an example, a reward associated with a level of a gamified challenge may be given to a user upon completion of such level by the user, wherein such completion of the level is based on the performing the one or more action by the user to get the token(s) required to complete the level. Therefore, in an implementation a user needs to collect particular token(s) or combination of tokens to complete each level of a gamified challenge. Further in such implementation upon reaching the required token(s) or the token combination for an active level, the user may be awarded with a targeted reward such as for example a targeted monetary a reward available for that active level. For such implementation the required number of tokens may be denoted as ‘rₙ’ where 1<rₙ≤kₙ.

Further, once the one or more tokens from the set of tokens are associated with the set of levels associated with the gamified challenge, next at step [208] the method comprises providing, by the processing unit [102] to one or more users via the digital platform accessed on one or more user device, the one or more action items. The one or more action items are provided to enable the one or more users to retrieve one or more tokens from the set of tokens. Also, the one or more action items are provided to permit the one or more users to transition to a next level from a current level based on the retrieval of the one or more tokens from the set of tokens required to transition to the next level. For example a user may execute a provided action item such as the user may complete an addition of 4 products in a virtual cart on an e-commerce platform to get say 2 tokens ‘A’ that are required to complete a 2^{nd} level of a gamified challenge launched on the e-commerce platform, wherein the addition of 4 products in the virtual cart further makes the user more familiar with the e-commerce platform in at least the terms of placing an order. Further, the one or more action items are associated with one or more rewards. More specifically as the one or more action items enable the one or more users to retrieve the one or more tokens required for completion of the one or more levels, therefore awarding the one or more rewards to the one or more users upon the completion of the one or more levels is based on the one or more action items.

Also, in an implementation each action item from the one or more action items may be further associated with the storyline associated with the gamified challenge. In an implementation the storyline include but not limited to a number of actions required to be performed in sequential and/or non-sequential manner at each level of the gamified challenge to complete such level. For example, if a gamified challenge is implemented on an e-commerce platform for 3 days then for day 2 the storyline may include but not limited to selecting a product, adding a product to a virtual cart, and performing a product filtering and/or sorting action etc. actions that are required to be performed in sequential and/or non-sequential manner at a 1^{st} level of the gamified challenge. Also, in an implementation completion of the one or more action items in the sequential and/or non-sequential manner may be considered as one or more trails to win and a trial to win may be denoted by ‘t’, where ‘t’ ∈{1, 2, . . . , T}∥ T is the maximum trials a user can take during the time period when the gamified challenge is launched/active. Furthermore, in one other implementation the one or more action items may be provided based on a pre-defined time limit. For example, if a gamified challenge is implemented on an e-commerce platform for 3 days then for day 2, 2 action items for a level say for level 2 of the gamified challenge may be provided for 4 times.

Next at step [210] the method comprises determining for each level from the set of levels, by the processing unit [102], a probability of retrieving the one or more tokens from the set of tokens by the one or more users. For instance, for the one or more levels from the set of levels the processing unit [102] determines an associated cumulative probability of completion of said one or more levels by one or more users. In an implementation the cumulative probability of completion of any level n is ‘P(n)’, where P(n)∈[0,1]. Further, the probability for each level is determined based on at least one of a pre-defined constraint and a probability determined for one or more previous levels of said each level. Also, in an implementation the pre-defined constraint is defined based at least on an expected number of users transitioning to the next level from the current level. Also, the expected number of users is determined based at least on a number of rewards to be distributed at each level from the set of levels. In an implementation the expected number of users for a current level may also be determined based on the expected number of users for one or more previous levels. Thus, in an implementation retrieval of a token upon completion of the one or more action items depends on a probability function which takes a level as an input. Also, in such implementation in-game tokens may be denoted by ‘Xₖ’∥ k∈{1, 2, . . . , K} and a number of tokens the one or more users may collect in the gamified challenge over levels may be denoted by ‘xₖ’∥k∈{1, 2, . . . , K}, where sum of all ‘xₖₙ,’ for a level ‘n’ is equal to ‘tₙ’. Further, in an implementation the one or more tokens retrieved by the one or more users may be carry forwarded to the next level after deduction of the required tokens for a current level.

Further, after determining the probability of retrieving the one or more tokens from the set of tokens by the one or more users an indication of the same is provided to the control unit [104], and thereafter at step [212] the method comprises automatically controlling, by the control unit [104], a number of users permitted to transition to the next level from the current level based on the probability determined for each level from the set of levels. More specifically, for automatically controlling the number of users permitted to transition to the next level from the current level, the control unit [104] may adjust the probability determined for each level from the set of levels based on at least of a current number of users transitioning to the next level from the current level and a drop of rate. The drop of rate is a rate at which users opts out of the gamified challenge within a given time period. Also, in an implementation the number of users who may complete any level n is denoted by a function EV(n), such that:

EV(n)=Π(P(n), P(n−1))
Where,
n is the level number,
EV(n) is the expected value of the probability of the users that cross a level n,
P(n) is the probability of a user crossing a current level, and
P(n−1) is the probability of a user crossing a previous level.

Once the number of users permitted to transition to the next level from the current level is automatically controlled, next at step [214] the method comprises automatically optimizing, by the optimization unit [106], the user engagement on the digital platform based on the automatic controlling of the number of users permitted to transition to the next level from the current level.

After automatically optimizing the user engagement on the digital platform, the method terminates at step [216].

Thus, the present invention provides a novel solution of automatic optimization of user engagement on a digital platform based on a gamified challenge. The present invention also provides a technical advancement over the currently known solutions by providing an automated control over the user movement across various levels of a gamified challenge on a digital platform without any manual monitoring. Also, the present invention is technically advanced over the currently known solutions as the increased control of user flow provided via the present solution converts to better rewards for the end-users given that the chances of exceeding the budget (i.e., the available rewards to be distributed) are practically nil. The present invention is also technically advanced over the currently known solutions as it provides a solution to adjust a probability of retrieving tokens at a given level based on a current number of users transitioning to a next level from a current level and/or a drop of rate of users, wherein changing a probability at a given level, gives an automated output in terms of the user movement across multiple levels. Furthermore, the present invention is also technically advanced over the currently known solutions as using the present solution multiple simulations can be created by changing different probabilities and output against each simulation can be observed which leads to strong data based output.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

1. A method of automatic optimization of user engagement on a digital platform, the method comprising:
generating, by a processing unit [102], a set of tokens for a gamified challenge on the digital platform;
associating, by the processing unit [102], one or more tokens from the set of tokens with a set of levels associated with the gamified challenge;
providing, by the processing unit [102] to one or more users via the digital platform accessed on one or more user device, one or more action items wherein:
the one or more action items are provided to enable the one or more users to retrieve one or more tokens from the set of tokens;
the one or more action items are associated with one or more rewards; and
the one or more action items are provided to permit the one or more users to transition to a next level from a current level;
determining for each level from the set of levels, by the processing unit, a probability of retrieving the one or more tokens from the set of tokens by the one or more users, wherein the probability for each level is determined based on at least one of a pre-defined constraint and a probability determined for one or more previous levels of said each level;
automatically controlling, by a control unit [104], a number of users permitted to transition to the next level from the current level based on the probability determined for each level from the set of levels; and
automatically optimizing, by an optimization unit [106], the user engagement on the digital platform based on the automatic controlling of the number of users permitted to transition to the next level from the current level.

2. The method as claimed in claim 1, wherein the pre-defined constraint is defined based at least on an expected number of users transitioning to the next level from the current level, and wherein the expected number of users is determined based at least on a number of rewards to be distributed at each level from the set of levels.

3. The method as claimed in claim 1, wherein each action item from the one or more action items is further associated with a storyline associated with the gamified challenge, wherein the gamified challenge is implemented on the digital platform for a pre-defined number of days.

4. The method as claimed in claim 1, wherein the one or more action items are provided based on a pre-defined time limit.

5. The method as claimed in claim 1, wherein automatically controlling, by the control unit [104], a number of users permitted to transition to the next level from the current level further comprises adjusting by the control unit [104] the probability determined for each level from the set of levels based on at least of a current number of users transitioning to the next level from the current level and a drop of rate.

6. A system of automatic optimization of user engagement on a digital platform, the system comprising:
a processing unit [102] configured to:
generate, a set of tokens for a gamified challenge on the digital platform;
associate, one or more tokens from the set of tokens with a set of levels associated with the gamified challenge;
provide to one or more users via the digital platform accessed on one or more user device, one or more action items; wherein:
the one or more action items are provided to enable the one or more users to retrieve one or more tokens from the set of tokens;
the one or more action items are associated with one or more rewards; and
the one or more action items are provided to permit the one or more users to transition to a next level from a current level; and
determine, for each level from the set of levels, a probability of retrieving the one or more tokens from the set of tokens by the one or more users, wherein the probability for each level is determined based on at least one of a pre-defined constraint and a probability determined for one or more previous levels of said each level;
a control unit [104] configured to automatically control a number of users permitted to transition to the next level from the current level based on the probability determined for each level from the set of levels; and
an optimization unit [106] configured to automatically optimize the user engagement on the digital platform based on the automatic controlling of the number of users permitted to transition to the next level from the current level.

7. The system as claimed in claim 6, wherein the pre-defined constraint is defined based at least on an expected number of users transitioning to the next level from the current level, and wherein the expected number of users is determined based at least on a number of rewards to be distributed at each level from the set of levels.

8. The system as claimed in claim 6, wherein each action item from the one or more action items is further associated with a storyline associated with the gamified challenge, wherein the gamified challenge is implemented on the digital platform for a pre-defined number of days.

9. The system as claimed in claim 6, wherein the one or more action items are provided based on a pre-defined time limit.

10. The system as claimed in claim 6, wherein for automatically controlling the number of users permitted to transition to the next level from the current level, the control unit [104] is further configured to adjust the probability determined for each level from the set of levels based on at least of a current number of users transitioning to the next level from the current level and a drop of rate.
